(19) United States
(12) Patent Application Publication
(10) Pub. No.: US 2026/0189025 A1
(43) Pub. Date: Jul. 2, 2026

(54) POWER STORAGE SYSTEM, SYSTEM, AND POWER STORAGE DEVICE

(71) Applicants: Akira SAITO, Kanagawa (JP); Hirokazu MIYAKE, Shizuoka (JP)

(72) Inventors: Akira SAITO, Kanagawa (JP); Hirokazu MIYAKE, Shizuoka (JP)

(21) Appl. No.: 19/131,957

(22) PCT Filed: Nov. 6, 2023
(86) PCT No.: PCT/IB2023/061143

§ 371 Date: May 22, 2025

(30) Foreign Application Priority Data
Nov. 24, 2022 (JP) 2022-187475

(51) Int. Cl. H02J 7/16; H02J 7/34; H02J 7/45; H02J 7/61; H02J 107/20

(52) U.S. Cl. CPC H02J 7/16; H02J 7/34; H02J 7/45; H02J 7/61; H02J 2107/20; H02J 2207/20; H02J 2207/40

(57) ABSTRACT

A power storage system comprises a rotating body, a generator to convert a rotational force of the rotating body into electric power, a secondary battery to store the electric power converted by the generator, and a controller to electrically connect the generator and the secondary battery to each other and control storage of the electric power converted by the generator in the secondary battery. The secondary battery is a three-terminal secondary battery having two positive electrodes that are short-circuited with each other, and one negative electrode. By applying a battery voltage of the three-terminal secondary battery to the generator via the controller, power generation by the generator is controlled, and a rotation speed of a rotor of the generator is controlled.

### TECHNICAL FIELD

The present disclosure relates to a power storage system, a system, and a power storage device.

### BACKGROUND ART

A known power generation device includes a rotating body and a generator that converts a rotational force of the rotating body into electric power, and stores the electric power generated by the generator in a secondary battery. For example, such a power generation device includes a rotation detection unit that detects a rotation speed of the generator, an electromagnetic brake that slows down the generator, and a power generation control unit that controls the power generation by the generator. When the rotation speed of the generator obtained from the rotation detection unit increases to a set rotation speed, the power generation control unit controls the electromagnetic brake and continues generating power while adjusting the rotation of the generator (for example, see PTL 1).

### CITATION LIST

### Patent Literature

### [PTL 1]

Japanese Patent No. 6577078

### SUMMARY OF INVENTION

### Technical Problem

However, when a power generation device includes a control mechanism such as a rotation speed detection unit and an electromagnetic brake to adjust the rotation of the generator, there is a problem that the cost of the power generation device increases.

In view of the above-described problems, an object of the present invention is to control the rotation speed of a rotor of a generator while preventing an increase in cost by utilizing the battery voltage of a three-terminal secondary battery.

### Solution to Problem

To solve the above-described technical problem, a power storage system according to one embodiment of the present invention includes a rotating body, a generator to convert a rotational force of the rotating body into electric power, a secondary battery to store the electric power converted by the generator, and a controller to electrically connects the generator and the secondary battery to each other and controls storage of the electric power converted by the generator in the secondary battery. The secondary battery includes a three-terminal secondary battery having two positive electrodes that are short-circuited with each other, and one negative electrode, and by applying a battery voltage of the three-terminal secondary battery to the generator via the controller, power generation by the generator is controlled, and a rotation speed of a rotor of the generator is controlled.

### Advantageous Effects of Invention

According to embodiments of the present invention, by utilizing the battery voltage of a three-terminal secondary battery, it is possible to control the rotation speed of a rotor of a generator while preventing an increase in cost.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a block diagram illustrating a first embodiment of a power storage system and a power storage device according to the present disclosure.

FIG. 2 is a circuit block diagram illustrating an example of a circuit configuration of the power storage system of FIG. 1.

FIG. 3 is a block diagram illustrating a second embodiment of a power storage system and a power storage device according to the present disclosure.

FIG. 4 is a block diagram illustrating a third embodiment of a power storage system and a power storage device according to the present disclosure.

FIG. 5 is a block diagram illustrating a fourth embodiment of a power storage system and a power storage device according to the present disclosure.

FIG. 6 is a block diagram illustrating a fifth embodiment of a power storage system and a power storage device according to the present disclosure.

FIG. 7 is a block diagram illustrating an example of a power storage system used in a power generation verification test.

FIG. 8A is an explanatory diagram illustrating an installation method of a hydraulic turbine generator of FIG. 7 in an open water channel and FIG. 8B is a table presenting an example of power generation verification results of the power storage system of FIG. 7.

FIG. 9 is a block diagram illustrating an example of another power storage system.

FIG. 10 is a block diagram illustrating a first embodiment of a system according to the present disclosure.

FIG. 11 is a block diagram illustrating a second embodiment of a system according to the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In the present disclosure, alternating current and direct current are respectively denoted as AC and DC.

Embodiments will be described below with reference to the drawings. In the following, voltage names are used as reference numerals for voltage lines through which a voltage is transmitted. In the drawings, the same constituent components are denoted by the same reference numerals, and redundant descriptions may be omitted.

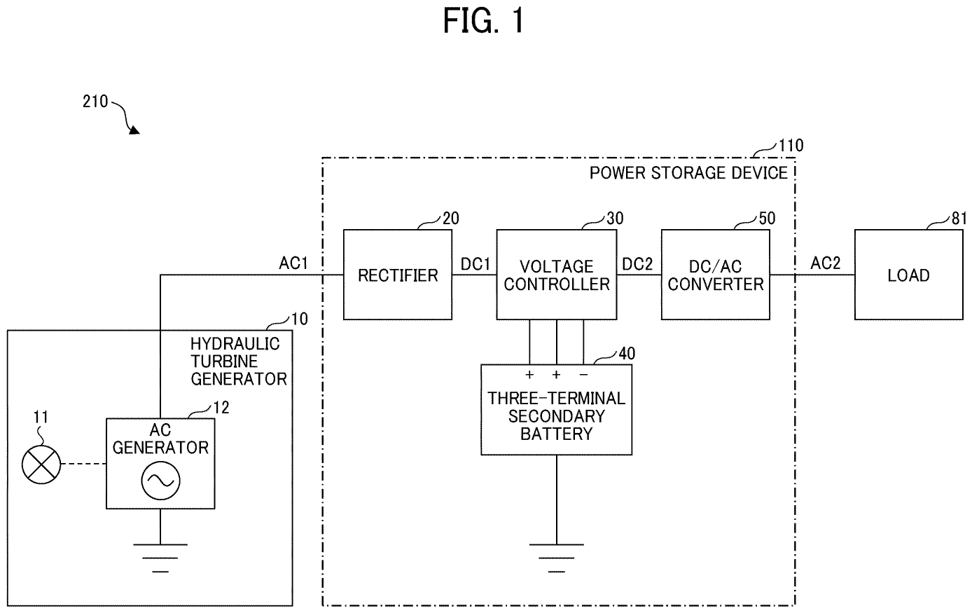

FIG. 1 is a block diagram illustrating a first embodiment of a power storage system and a power storage device according to the present disclosure. A power storage system 210 illustrated in FIG. 1 is a nano-pico hydroelectric power generation device with a power generation output of about 1 W or more and 30 kW or less. The power storage system 210 includes a hydraulic turbine generator 10, a power storage device 110, and a load 81. Note that the load 81 may be arranged outside the power storage system 210.

The hydraulic turbine generator 10 includes an AC generator 12 and a hydraulic turbine 11 formed of a rotating body having a rotary blade. The power storage device 110 includes a rectifier 20, a voltage controller 30, a three-terminal secondary battery 40, and a DC/AC converter 50. The output voltage of the three-terminal secondary battery 40 is not particularly limited, but is 12 V, for example.

For example, the AC generator 12 is a three-phase AC generator that is mechanically connected to the hydraulic turbine 11 and generates an alternating current voltage AC1 in response to the rotation of the hydraulic turbine 11. When the rotor of the AC generator 12 rotates in conjunction with the rotation of the hydraulic turbine 11 by the water flow, an induced voltage is generated in an armature (coil) provided on a stator side of the AC generator 12. The generated induced voltage is proportional to the rotation speed of the hydraulic turbine 11 until a magnetic saturation region, and the induced voltage of the AC generator 12 also changes in conjunction with the change in the rotation speed of the hydraulic turbine 11 by the water flow.

The rectifier 20 rectifies the alternating current voltage AC1 from the AC generator 12 to generate a direct current voltage DC1. The direct current voltage DC1 is supplied to the voltage controller 30. The voltage controller 30 controls the power storage of the three-terminal secondary battery 40 in accordance with the alternating current voltage DC1 received from the rectifier 20. For example, the voltage controller 30 may have a mechanism that prevents over-charge and over-discharge of the three-terminal secondary battery 40 and prevents a deterioration of the three-terminal secondary battery 40. Further, the voltage controller 30 outputs, to the DC/AC converter 50, an electric charge stored in the three-terminal secondary battery 40 or an electric charge supplied from the rectifier 20 via the three-terminal secondary battery 40, as a direct current voltage DC2.

The three-terminal secondary battery 40 includes two positive electrodes + that are short-circuited with each other, and one negative electrode −. The voltage controller 30 connects a direct voltage line DC1 to one of the two positive electrodes + of the three-terminal secondary battery 40. The voltage controller 30 supplies the electric charge stored in the three-terminal secondary battery 40 to a direct current voltage line DC2, or supplies the direct current voltage DC1 output from the rectifier 20 to the direct current voltage line DC2, via the two positive electrodes + of the three-terminal secondary battery 40. That is, the electric power generated by the hydraulic turbine generator 10 is supplied from the three-terminal secondary battery 40 to the DC/AC converter 50, or is supplied to the DC/AC converter 50 via the two positive electrodes + of the three-terminal secondary battery 40.

The DC/AC converter 50 converts the direct current voltage DC2 into an alternating current voltage AC2 and supplies the alternating current voltage AC2 to the load 81. The electric power generated by the hydraulic turbine generator 10 or the electric power stored in the three-terminal secondary battery 40 is consumed by the load 81. For example, the DC/AC converter 50 may convert the direct current voltage DC2 discharged from the three-terminal secondary battery 40 into the alternating current voltage AC2 of 100 V used in general home appliances and the like. Note that the alternating current voltage AC2 generated by the conversion by the DC/AC converter 50 is not limited to 100 V, and may be converted to a voltage value used by the load 81.

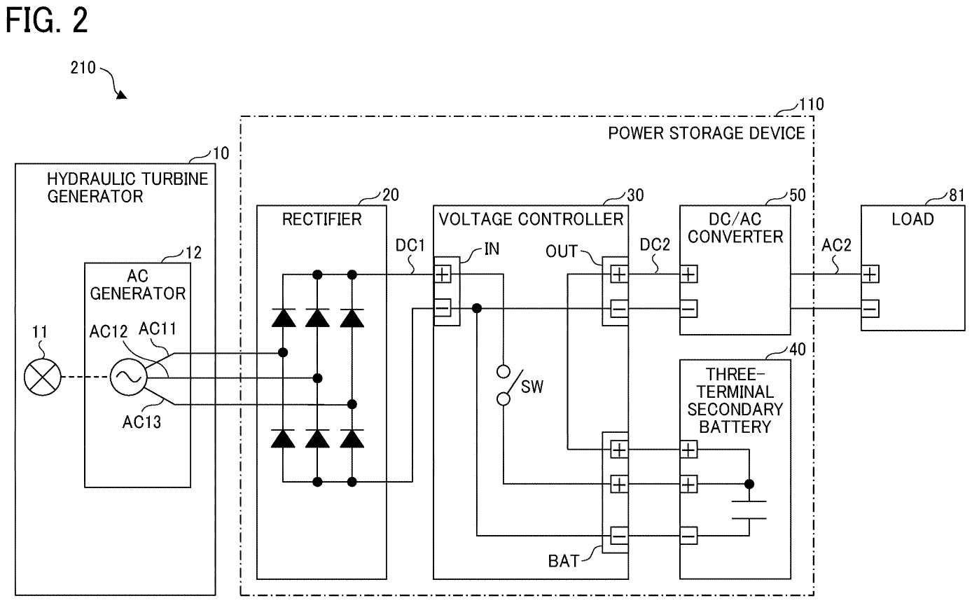

The three-terminal secondary battery 40 is connected in parallel to the AC generator 12, as described in FIG. 2. Therefore, the direct current voltage DC1 output from the three-terminal secondary battery 40 is converted into the alternating current voltage AC1 by the rectifier 20. The alternating current voltage AC1 converted from the direct current voltage DC1 is used to control the voltage generated by the armature (coil) of the AC generator 12, and regulate the rotation speed of the hydraulic turbine 11.

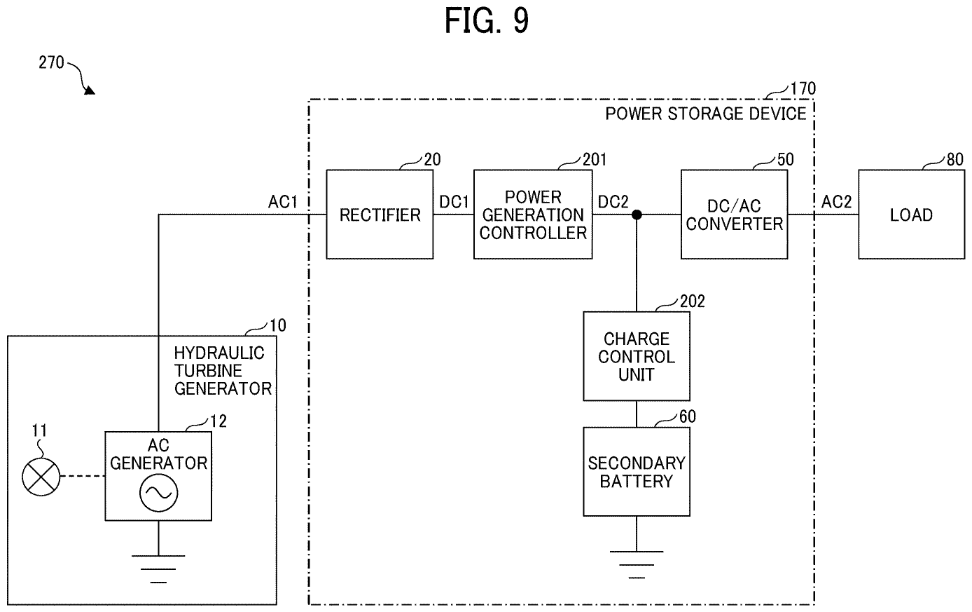

For example, it is preferable to use a secondary battery having an internal resistance of 60 m 22. Ah or less as the three-terminal secondary battery 40. Thus, heat generation of the three-terminal secondary battery 40 can be prevented, and the risk of smoke generation and ignition due to over-charge and over-discharge can be reduced. Further, a charge control unit (such as a charge control unit 202 illustrated in FIG. 9, for example) that controls charging to protect the three-terminal secondary battery 40 can be eliminated. Moreover, heat loss can be prevented, and even when the output power of the AC generator 12 is small and the charging current to the three-terminal secondary battery 40 is small, the three-terminal secondary battery 40 can be charged well.

For example, to efficiently store power in the three-terminal secondary battery 40, it is preferable to use, as the three-terminal secondary battery 40, a lithium ion battery in which a change in input voltage and a change in the amount of stored power are correlated. Further, among lithium ion batteries, it is preferable to use a lithium ion battery in which the positive electrode uses an active material having at least one of an olivine structure and a spinel structure, which has a low risk of smoke generation and ignition and has low internal resistance.

By using a lithium ion battery in which the positive electrode uses an active material having at least one of an olivine structure and a spinel structure, the rotation speed of the AC generator 12 can be stably controlled and the output voltage of the AC generator 12 can be maintained constant. For example, by using a lithium manganate compound having a spinel structure with low internal resistance, the internal resistance can be reduced to 60 mΩ·Ah or less. Iron phosphate can be used as the active substance having an olivine structure. Manganese oxide can be used as the active substance having a spinel structure.

FIG. 2 is a circuit block diagram illustrating an example of a circuit configuration of the power storage system 210 of FIG. 1. For example, the rectifier 20 is a three-phase full-wave rectifier circuit that converts the three-phase alternating current voltage AC1 (AC11, AC12, and AC13) supplied from the AC generator 12 into the direct current voltage DC1.

The voltage controller 30 includes an input terminal IN (a positive electrode + and a negative electrode −) connected to the rectifier 20 and an output terminal OUT (a positive electrode + and a negative electrode −) connected to the DC/AC converter 50. Further, the voltage controller 30 includes a power storage terminal BAT (two positive electrodes + and one negative electrode −) connected to the three-terminal secondary battery 40. The two positive electrodes + of the power storage terminal BAT are short-circuited within the three-terminal secondary battery 40.

In the voltage controller 30, the positive electrode + of the input terminal IN is connected to one of the two positive electrodes + of the three-terminal secondary battery 40 via a switch SW. The negative electrode − of the input terminal IN is connected to the negative electrode − of the three-terminal secondary battery 40 and the negative electrode − of the output terminal OUT. The other one of the two positive electrodes + of the three-terminal secondary battery 40 is connected to the positive electrode + of the output terminal OUT.

For example, the voltage controller 30 turns off the switch SW when the three-terminal secondary battery 40 is fully charged and there is a risk of over-charge, and otherwise, turns on the switch SW. The three-terminal secondary battery 40 is charged with the direct current voltage DC1, until the three-terminal secondary battery 40 is fully charged.

The two positive electrodes + of the three-terminal secondary battery 40 are short-circuited, and thus, after the three-terminal secondary battery 40 is fully charged, the direct current voltage DC1 supplied from the rectifier 20 passes through the three-terminal secondary battery 40 and is supplied to the DC/AC converter 50 as the direct current voltage DC2. After the three-terminal secondary battery 40 is fully charged, no current flows inside the three-terminal secondary battery 40, so that it is possible to prevent a decrease in discharge efficiency.

In the power storage system 210 illustrated in FIG. 2, the voltage controller 30 connects the positive electrode + and the negative electrode − of the three-terminal secondary battery 40 to the rectifier 20 via the positive electrode + and the negative electrode − of the input terminal IN, respectively. That is, the three-terminal secondary battery 40 is connected in parallel with the AC generator 12 via the voltage controller 30. Thus, the rotation speed of the rotor of the AC generator 12 can be controlled by the battery voltage of the three-terminal secondary battery 40.

Specifically, the battery voltage of the three-terminal secondary battery 40 is applied to the AC generator 12, and thus, the induced voltage generated in the armature of each phase of the AC generator 12 is controlled to a value obtained by subtracting the voltage drop due to the internal resistance of the AC generator 12 from the battery voltage of the three-terminal secondary battery 40. By controlling the induced voltage, the rotating magnetic field generated by the current flowing through the armature of each phase changes, and the rotor is slowed down.

Accordingly, by applying the battery voltage of the three-terminal secondary battery 40 to the AC generator 12, the rotation speed of the AC generator 12 can be controlled, to automatically control the output voltage (induced voltage) of the AC generator 12, without providing a control unit or the like that controls the rotation speed of the AC generator 12. As a result, it is possible to prevent the application of an over-voltage to the three-terminal secondary battery 40, and prevent damage and deterioration of the three-terminal secondary battery 40.

As described above, in the first embodiment of the power storage system and the power storage device, by utilizing the battery voltage of the three-terminal secondary battery, there is no need to provide a control unit or the like for controlling the rotation speed of the AC generator 12. Thus, the rotation speed of the rotor of the AC generator 12 can be controlled while preventing an increase in cost. Further, the number of circuit components and the like used to control the rotation speed of the AC generator 12 can be reduced, so that the reliability of the power storage system can be improved.

By using a lithium ion battery as the three-terminal secondary battery 40, it is possible to correlate a change in the input voltage and a change in the amount of stored power, so that the rotation speed of the rotor of the AC generator 12 can be controlled with high accuracy. By using an active material having a spinel structure or an olivine structure for the positive electrode of the three-terminal secondary battery, the rotation speed of the AC generator 12 can be stably controlled, and the output voltage of the AC generator 12 can be maintained constant. Therefore, it is possible to provide a nano-pico hydroelectric power generation device with low cost and high reliability.

When the AC generator 12 is used in the hydraulic turbine generator 10, the rectifier 20 is arranged between the AC generator 12 and the voltage controller 30, so that the alternating current voltage AC1 generated from the AC generator 12 can be converted into the direct current voltage DC1 and supplied to the voltage controller 30. Further, by converting the battery voltage of the three-terminal secondary battery 40 into the alternating current voltage AC1 and applying the alternating current voltage AC1 to the AC generator 12, the rotation speed of the AC generator 12 can be controlled. For example, the rotation speed of the AC generator 12 can be controlled by connecting the three-terminal secondary battery 40 in parallel with the AC generator 12.

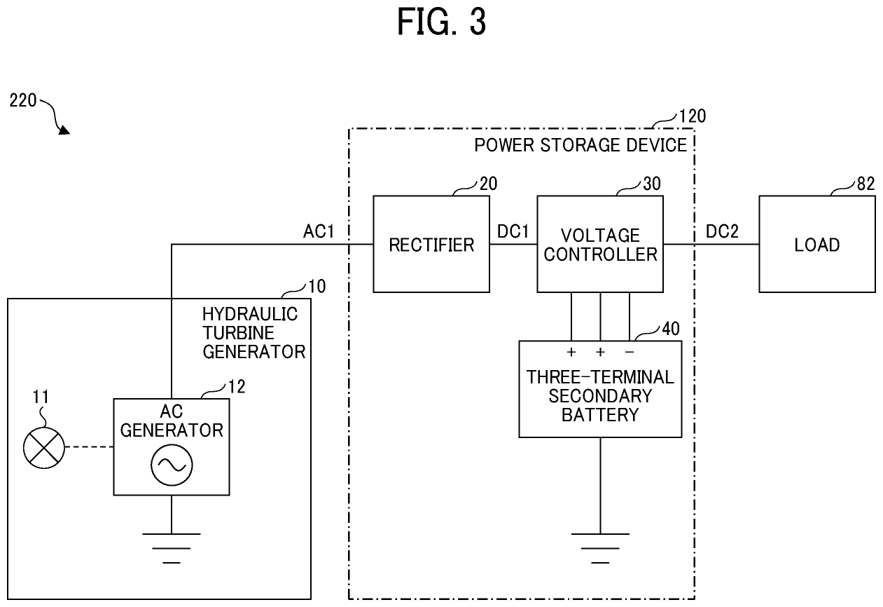

FIG. 3 is a block diagram illustrating a second embodiment of a power storage system and a power storage device according to the present disclosure. Elements similar to those in FIG. 1 are denoted by the same reference numerals, and detailed description thereof will be omitted. A power storage system 220 illustrated in FIG. 3 includes the hydraulic turbine generator 10 and a power storage device 120.

The power storage device 120 is connected to a load 82 that operates when receiving the direct current voltage DC2. Therefore, the battery voltage of the three-terminal secondary battery 40 of the power storage device 120 is adjusted in advance to a rated DC voltage of the load 82 that operates when receiving the direct current voltage DC2. The power storage device 120 does not include the DC/AC converter 50 of the power storage device 110 in FIG. 1. The circuit configurations of the power storage system 220 and the power storage device 120 are respectively similar to the circuit configurations of the power storage system 210 and the power storage device 110 in FIG. 1, except that the DC/AC converter 50 is not provided and the load 82 is provided instead of the load 81.

As described above, also in the second embodiment of the power storage system and the power storage device, it is possible to obtain a similar effect as in the first embodiment of the power storage system and the power storage device. Further, according to the present embodiment, it is possible to provide the power storage device 120 that supplies the direct current voltage DC2 to the load 82. By connecting the power storage device 120 to the load 82 that uses the direct current voltage DC2, the DC/AC converter 50 in FIG. 1 is not required, so that it is possible to control the rotation speed of the rotor of the AC generator 12 while further preventing an increase in cost. Moreover, the loss due to the conversion from the direct current voltage DC2 to the alternating current voltage AC2 can be eliminated.

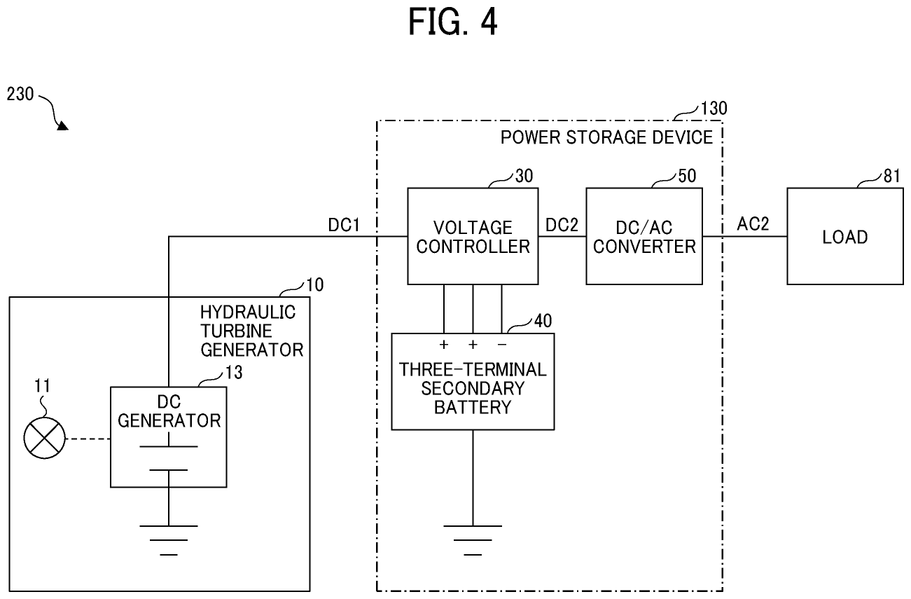

FIG. 4 is a block diagram illustrating a third embodiment of a power storage system and a power storage device according to the present disclosure. Elements similar to those in FIG. 1 are denoted by the same reference numerals, and detailed description thereof will be omitted. A power storage system 230 illustrated in FIG. 4 includes the hydraulic turbine generator 10 and a power storage device 130.

The hydraulic turbine generator 10 includes a DC generator 13 instead of the AC generator 12 of FIG. 1. The DC generator 13 generates the direct current voltage DC1, and thus, the power storage device 130 does not include the rectifier 20 in FIG. 1. The circuit configuration of the power storage system 230 is similar to the circuit configuration of the power storage system 210 in FIG. 1, except that the DC generator 13 is provided instead of the AC generator 12 and the power storage device 120 does not include the rectifier 20.

As described above, also in the third embodiment of the power storage system and the power storage device, it is possible to obtain a similar effect as in the first embodiment of the power storage system and the power storage device. Further, according to the present embodiment, it is possible to provide the power storage device 130 that stores the direct current voltage DC1 generated by the DC generator 13 and supplies the stored electric power to the load 81 as the alternating current voltage AC2. By using the DC generator 13, the rectifier 20 in FIG. 1 is not required, so that it is possible to control the rotation speed of the rotor of the AC generator 12 while further preventing an increase in cost. Furthermore, it is possible to eliminate loss caused by the conversion from the alternating current voltage AC1 to the direct current voltage DC1.

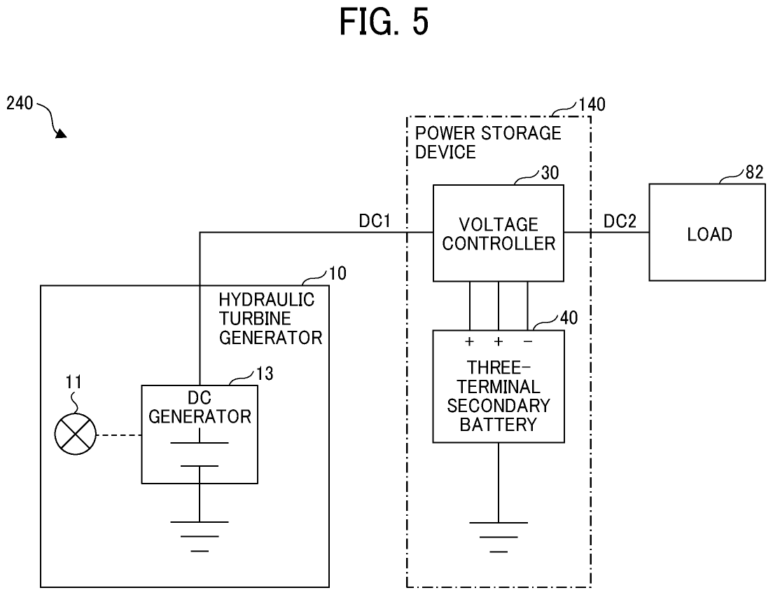

FIG. 5 is a block diagram illustrating a fourth embodiment of the power storage system and the power storage device according to the present disclosure. Elements similar to those in FIG. 1 are denoted by the same reference numerals, and detailed description thereof will be omitted. A power storage system 240 illustrated in FIG. 5 includes the hydraulic turbine generator 10 and a power storage device 140.

The hydraulic turbine generator 10 includes the DC generator 13 instead of the AC generator 12 of FIG. 1. In the power storage device 140, the rectifier 20 and the DC/AC converter 50 are omitted from the power storage device 110 in FIG. 1. The circuit configuration of the power storage system 240 is similar to the circuit configuration of the power storage system 210 in FIG. 1, except that the DC generator 13 is provided instead of the AC generator 12, the power storage device 140 does not include the rectifier 20 and the DC/AC converter 50, and the load 82 is provided instead of the load 81.

As described above, also in the fourth embodiment of the power storage system and the power storage device, it is possible to obtain a similar effect as in the first embodiment of the power storage system and the power storage device. Further, according to the present embodiment, it is possible to provide the power storage device 130 that stores the direct current voltage DC1 generated by the DC generator 13 and supplies the stored electric power to the load 82 as the direct current voltage DC2. Thus, the rotation speed of the rotor of the AC generator 12 can be controlled while further preventing an increase in cost. Moreover, the loss due to the conversion from the alternating current voltage to the direct current voltage can be eliminated.

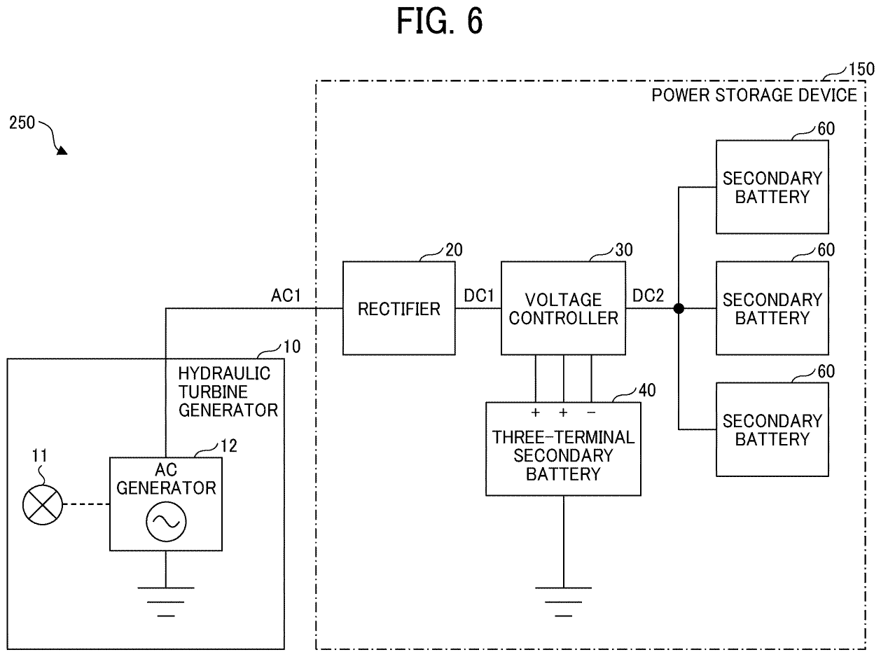

FIG. 6 is a block diagram illustrating a fifth embodiment of the power storage system and the power storage device according to the present disclosure. Elements similar to those in FIG. 1 are denoted by the same reference numerals, and detailed description thereof will be omitted. The circuit configuration of a power storage system 250 illustrated in FIG. 6 is similar to the circuit configuration of the power storage system 210 in FIG. 1, except that a power storage device 150 includes a plurality of secondary batteries 60 instead of the DC/AC converter 50.

For example, each of the secondary batteries 60 is attachably and detachably connected to the power storage device 150. Accordingly, the secondary battery 60 storing power in the power storage device 150 can be removed from the power storage device 150 and connected to a load to be used.

As described above, also in the fifth embodiment of the power storage system and the power storage device, it is possible to obtain a similar effect as in the first embodiment of the power storage system and the power storage device. Further, in the present embodiment, the power storage device 150 is provided that stores power in the secondary batteries 60 that are attachably and detachably connected to the power storage device 150. Therefore, electric power can be supplied to a load, without drawing a power cable to the load installed at a location separated from the power storage device 150.

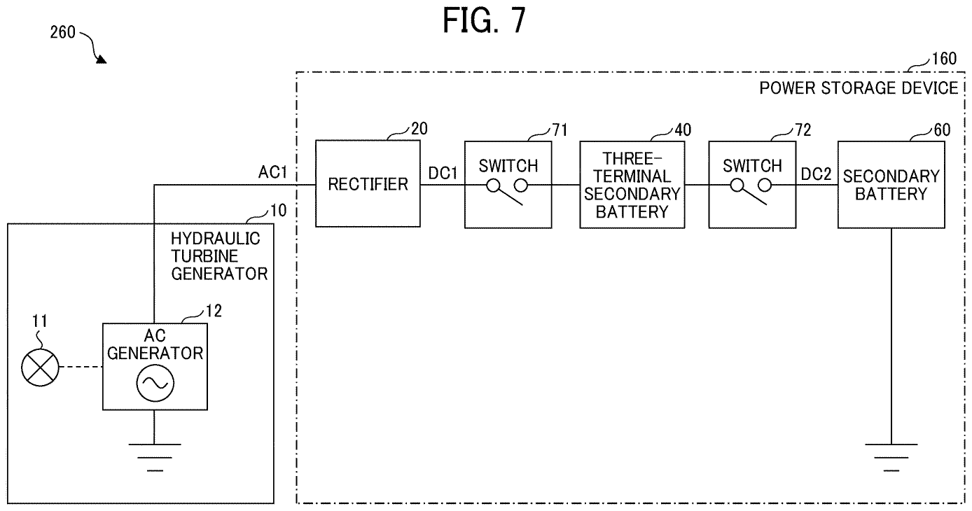

FIG. 7 is a block diagram illustrating an example of a power storage system used in a power generation verification test. Elements similar to those in FIGS. 1 and 6 are denoted by the same reference numerals, and detailed description thereof will be omitted. A power storage system 260 illustrated in FIG. 7 includes a power storage device 160 and the hydraulic turbine generator 10 including the AC generator 12. The power storage device 160 includes the rectifier 20, a switch 71, the three-terminal secondary battery 40, a switch 72, and the secondary battery 60. The output (DC1) of the rectifier 20 is connected to the three-terminal secondary battery 40 via the switch 71, and the three-terminal secondary battery 40 is connected to the secondary battery 60 (DC2) via the switch 72.

One of the positive electrodes of the three-terminal secondary battery 40 is connected to the positive electrode of the rectifier 20 via the switch 71, and the other positive electrode of the three-terminal secondary battery 40 is connected to the positive electrode of the secondary battery 60 via the switch 72. The two positive electrodes of the three-terminal secondary battery 40 are short-circuited inside the battery, so that, when the switches 71 and 72 are closed, the positive electrode of the rectifier 20 is connected to the positive electrode of the secondary battery 60 via the three-terminal secondary battery 40. When the switches 71 and 72 are closed, the negative electrode of the rectifier 20 is connected to the negative electrode of the three-terminal secondary battery 40 and the negative electrode of the secondary battery 60.

In the verification test, a lithium manganate secondary battery is used as the secondary battery 60, for example.

The switches 71 and 72 are provided so that a tester can reliably confirm the connection between the AC generator 12 and the three-terminal secondary battery 40 and the connection between the three-terminal secondary battery 40 and the secondary battery 60.

In the verification test, first, the AC generator 12 is connected to the three-terminal secondary battery 40 by closing the switch 71, and in a state where the switch 72 is open, the rotation speed of the hydraulic turbine 11 and a change in the voltage generated by the AC generator 12 are confirmed. Next, the three-terminal secondary battery 40 is connected to the secondary battery 60 by closing the switch 72. It is confirmed whether current flows from the three-terminal secondary battery 40 to the secondary battery 60, and a change in the voltage in accordance with the current is confirmed.

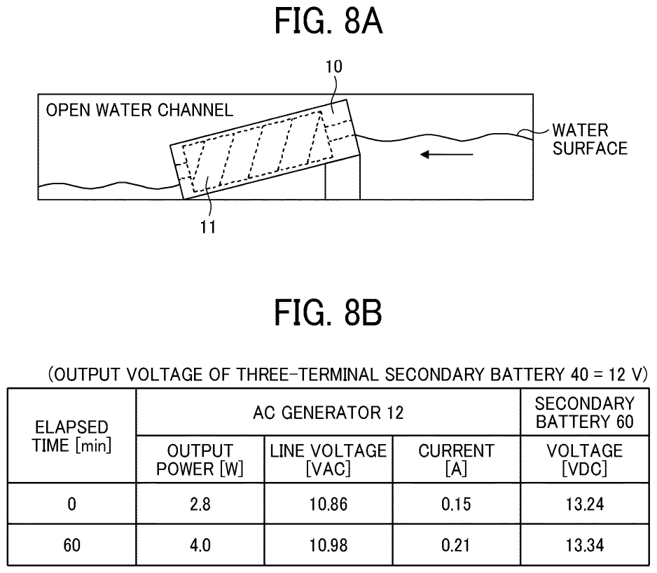

FIG. 8A is an explanatory diagram illustrating an installation method of the hydraulic turbine generator 10 of FIG. 7 in an open water channel, and FIG. 8B is a table presenting an example of power generation verification results of the power storage system of FIG. 7. Note that the hydraulic turbine generator 10 illustrated in the above-described first to fifth embodiments can also be installed in an open water channel, similarly to FIG. 8A. For example, the hydraulic turbine generator 10 includes a helical hydraulic turbine 11. The hydraulic turbine generator 10 is installed on a water surface of an open water channel in a state where the helical hydraulic turbine 11 is inclined so that an upstream side of the helical hydraulic turbine 11 is higher. In the hydraulic turbine generator 10, the helical hydraulic turbine 11 rotates by the inflow of water to generate electric power.

The table illustrated in FIG. 8B presents various types of data acquired in the power generation verification test. For example, in the verification test, the three-terminal secondary battery 40 having an output voltage of 12 V was used. A line voltage of the AC generator 12 in the table indicates a voltage difference between two of the three phases. In the verification test, the output power immediately after the AC generator 12 starts generating electric power (0 minutes) was 2.8 W, and the output power after 60 minutes was 4.0 W. After 60 minutes, the voltage of the secondary battery 60 increased from 13.24 V to 13.34 V (both DC voltages) by the electric power generated by the hydraulic turbine generator 10, and it was confirmed that the secondary battery 60 normally stores power. Therefore, it was understood that the power storage system 260 illustrated in FIG. 7 can generate electric power by using hydraulic power. That is, it was understood that the power storage systems 210, 220, and 250 illustrated in FIGS. 1, 3, and 6 can generate electric power by using hydraulic power.

Note that, instead of the hydraulic turbine generator 10 illustrated in FIG. 7, also in a case where a stabilized power source is connected to the switch 71 of the power storage device 160 without interposing the rectifier 20, and a DC voltage is supplied from the stabilized power source to the three-terminal secondary battery 40, it was confirmed that the secondary battery 60 normally stores power, as illustrated in the table in FIG. 8B. That is, it was understood that the secondary battery 60 normally stores power, even when the DC generator 13 illustrated in FIGS. 4 and 5 is used to perform hydroelectric power generation.

FIG. 9 is a block diagram illustrating an example of another power storage system. Elements similar to those in FIG. 1 are denoted by the same reference numerals, and detailed description thereof will be omitted. A power storage system 270 illustrated in FIG. 9 includes the hydraulic turbine generator 10 and a power storage device 170. The power storage device 170 includes the rectifier 20, a power generation controller 201, a charge control unit 202, the secondary battery 60, and the DC/AC converter 50.

The power generation controller 201 uses Maximum Power Point Tracking (MPPT) control to convert the direct current voltage DC1 into the charge amount of the secondary battery 60, and to convert the current value into an optimum amount to be supplied to the secondary battery 60.

In the case of small-sized hydroelectric power generation equipment such as a nano-pico hydroelectric power generation device, the electric power is generally generated by installing the hydraulic turbine 11 in a river. When generating electric power by causing the hydraulic turbine 11 to rotate by the water flow of a river in this manner, the rotation speed of the hydraulic turbine 11 changes depending on the water flow of the river, and the electric power of the AC generator 12 fluctuates.

The power generation controller 201 has a current-voltage curve algorithm in accordance with the characteristics of the hydraulic turbine 11, and converts the generated voltage of the AC generator 12 into the battery voltage of the secondary battery 60, and also raises the current value flowing in the secondary battery 60 to the maximum, based on the algorithm.

However, the current-voltage curve algorithm differs for each characteristic of the hydraulic turbine 11, and thus, it is desirable to input an appropriate algorithm for each hydraulic turbine 11. Note that, also in a wind power generation device in which the rotation speed of the wind turbine changes depending on the air flow, a power generation control unit is provided to control the rotation speed of the generator, and thus, is desirable to input an appropriate algorithm for each wind turbine.

For example, the charge control unit 202 closes a valve installed in an open water channel when the secondary battery 60 is fully charged. By closing the valve to stop the flow of water to the hydraulic turbine 11, the rotation of the hydraulic turbine 11 is stopped, power generation by the AC generator 12 is stopped, and the secondary battery 60 is protected from over-charging.

As described above, the power storage system 270 illustrated in FIG. 9 preferably includes the power generation controller 201 that converts the alternating current voltage AC1 output from the AC generator 12 into a voltage and a current for appropriately charging the secondary battery 60. Further, it is preferable to provide the charge control unit 202 or the like for protecting the secondary battery 60. Thus, there is a problem that the cost of the power storage system 270 and the power storage device 170 increases. Further, there is also a problem that a space for installing a control device including the power generation controller 201 and the charge control unit 202 is desired, and the size of the power storage device 170 increases. Moreover, there is also the problem that conversion loss occurs when the power generation controller 201 converts the voltage and current to an appropriate voltage and current for charging the secondary battery 60.

Note that, even if a chemical battery such as a lead secondary battery or a redox flow battery is connected in parallel to the AC generator 12, the rotation speed of the AC generator 12 can be controlled to a constant rotation speed in the initial charging stage. However, as the charging of the battery progresses, the internal resistance increases, and the battery voltage (=current amount*internal resistance) applied to the AC generator 12 increases. When the battery voltage increases, the induced voltage in the armature of each phase of the AC generator 12 increases, and the rotation speed of the rotor increases. As a result, the output voltage and the output current from the AC generator 12 increase, and the charging voltage value and the charging current value used for charging the secondary battery 60 increase.

As a result, there is a risk that overvoltage and overcurrent are supplied to the secondary battery 60, and if an electrolysis reaction occurs within the battery, deterioration of the battery may be promoted. In the worst case, the secondary battery 60 may be damaged. Therefore, when using chemical batteries such as lead secondary batteries and redox flow batteries, it is preferable to increase the battery capacity to eight times or more the capacity of the AC generator 12, for example, to delay the time until the battery is fully charged. Further, it is preferable to provide a charge control unit that controls charging and to stop charging the secondary battery 60 before the secondary battery 60 is fully charged. As a result, the cost of the power storage device and the power storage system increases.

Further, chemical batteries such as lead secondary batteries and redox flow batteries can be charged and discharged at the same time. However, the chemical reactions of charging and discharging are in opposite directions (hysteresis), and thus, a reverse voltage is applied to an electrode surface. If a reaction interface of the battery is damaged by the reverse voltage, the battery life decreases. Therefore, if a chemical battery is used that applies the battery voltage of the secondary battery 60 to the AC generator 12 (discharges toward the generator) while charging the output power of the AC generator 12, the battery life of the secondary battery 60 may be shortened.

On the other hand, the lithium ion battery used in the three-terminal secondary battery 40 indicated in each embodiment described above has a higher capacity density than a lead battery, has a voltage corresponding to the capacity in a narrow range, and is a non-chemical battery in which a charge transfer of a capacitor is replaced by a transfer of lithium ions. In the lithium ion battery, the internal resistance is substantially constant when the charge amount is 80% or less, and the battery voltage can be maintained substantially constant, even if the charging progresses. Further, the movement of the lithium ions depends on the current and does not influence the voltage. Therefore, even when the battery is fully charged, the battery voltage remains approximately constant, as long as current flows in the battery (discharge state).

For example, in each of the above-described embodiments, as described with reference to FIG. 2, the three-terminal secondary battery 40 is connected in parallel with the AC generator 12 and the battery voltage of the three-terminal secondary battery 40 is applied to the AC generator 12 (is discharged to the generator). Therefore, during charging by the AC generator 12, the three-terminal secondary battery 40 is constantly being discharged and current is flowing. Accordingly, even when the three-terminal secondary battery 40 is fully charged, the battery voltage can be maintained substantially constant.

By using such a lithium ion battery as the three-terminal secondary battery 40, even when the charging of the three-terminal secondary battery 40 progresses, the battery voltage applied to the AC generator 12 can be maintained substantially constant. The induced voltage in the armature of each phase of the AC generator 12 can be controlled to be substantially constant, and the rotation speed of the generator can be maintained substantially constant. Thus, the voltage used to charge the three-terminal secondary battery 40 can be maintained substantially constant. The torque of the AC generator 12 is converted into current, and thus, it is possible to prevent the application of an overvoltage to the three-terminal secondary battery 40.

Further, lithium ion batteries do not require dissociation energy associated with chemical reactions during charging and discharging, and thus, unlike general chemical batteries, there is no hysteresis when charging and discharging are performed simultaneously. Therefore, even when discharging is performed simultaneously to charging, the reaction interface of the battery is not damaged, and a decrease in battery life can be prevented. Accordingly, in the configurations of the first to fifth embodiments, the battery voltage of the three-terminal secondary battery 40 is applied to the AC generator 12 while charging the three-terminal secondary battery 40 with the output power from the AC generator 12, and thus, the three-terminal secondary battery 40 can be used over a long period of time.

Further, considering inrush current, it is preferable to use, as the three-terminal secondary battery 40, a lithium iron phosphate ion battery that uses phosphorus oxide having an olivine structure as the positive electrode material, or a lithium manganate ion battery that uses manganese oxide having a spinel structure as the positive electrode material.

Lithium manganate ion batteries and lithium iron phosphate ion batteries have a low risk of smoke generation and ignition, and in particular, manganese spinel has a low internal impedance. Therefore, by using a lithium manganate ion battery and a lithium iron phosphate ion battery, it is possible to reduce the risk of smoke generation and ignition when an inrush current occurs.

Although not used in the embodiments described above, in general ternary system positive electrode materials and cobalt acid positive electrode materials, the charging current and the charging voltage are strongly limited to prevent thermal runaway. Therefore, it is preferable to provide a protection circuit. However, the protection circuit increases the internal resistance of the secondary battery and reduces the charging efficiency.

By using a manganese-based positive electrode material having a spinel structure or a phosphoric acid-based positive electrode material having an olivine structure, which have a low risk of smoke generation and ignition, the protective circuit is not required, so that the cost can be reduced and the internal resistance of the power storage device can be lowered. As described above, the output power of the AC generator 12 can be controlled by the three-terminal secondary battery 40, and thus, power can be supplied to the three-terminal secondary battery 40 without providing a protection circuit, and the charging efficiency can be increased. Further, manganese, phosphorus, and iron are abundant materials and do not pose resource problems such as cobalt that is used in ternary systems, which is extremely beneficial for the widespread use of this system around the world.

If the internal resistance of the three-terminal secondary battery 40 is reduced to 60 mΩ·Ah or less, heat generation in the three-terminal secondary battery 40 can be prevented. Therefore, the thermal stability can be increased, and the risk of smoke generation and ignition due to over-charge or over-discharge can be reduced. Further, by reducing the internal resistance to 60 mΩ·Ah or less, it is possible to prevent a decrease in the charging efficiency due to internal resistance.

Therefore, even when the charging current flowing in the three-terminal secondary battery 40 is small, the three-terminal secondary battery 40 can be efficiently charged. By using a lithium ion battery as the three-terminal secondary battery 40, the internal resistance of the battery can be designed to be 60 mΩ·Ah or less, and from this viewpoint as well, it is preferable to use a lithium ion battery.

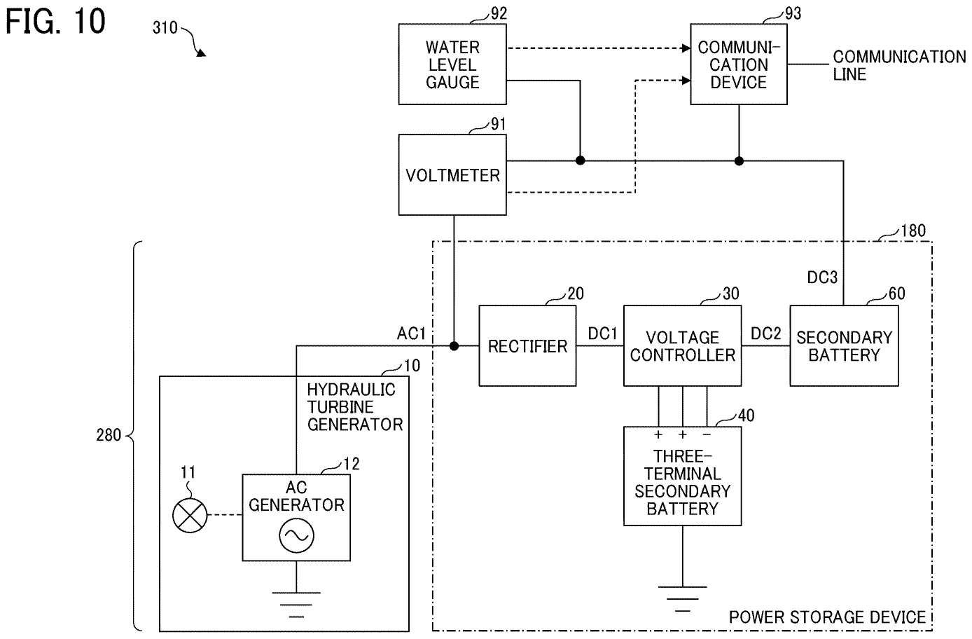

FIG. 10 is a block diagram illustrating a first embodiment of the system according to the present disclosure. Elements similar to those in FIGS. 1 and 6 are denoted by the same reference numerals, and detailed description thereof will be omitted. A system 310 illustrated in FIG. 10 includes a power storage system 280, a voltmeter 91, a water level gauge 92, and a communication device 93. The power storage system 280 includes the hydraulic turbine generator 10 and a power storage device 180.

The power storage device 180 is similar to the power storage device 150 in FIG. 6, except that the secondary battery 60 is not attachable and detachable and the number of the secondary batteries 60 being provided is different. The voltmeter 91, the water level gauge 92, and the communication device 93 operate in response to a direct current voltage DC 3 output from the secondary battery 60.

The voltmeter 91 measures a value of the alternating current voltage AC1 output by the AC generator 12 and notifies the communication device 93 of the measured value. Note that the voltmeter 91 may measure the direct current voltage DC1 output by the rectifier 20.

Alternatively, voltmeters for the alternating current voltage AC1 and the direct current voltage DC1 may be provided, respectively. The water level gauge 92 measures the water level of the open water channel illustrated in FIG. 8A and notifies the communication device 93 of the measured water level.

As described above, in the first embodiment of the system, the communication device 93 transmits, at a predetermined frequency, the voltage value received from the voltmeter 91 and the water level received from the water level gauge 92 to a personal computer located at a remote location, a mobile device, or a data storage device, via a communication line. Thus, for example, a decrease in the flow rate of water flowing in the open water channel (including clogging due to debris) can be confirmed by using an application on a personal computer or a mobile device.

Similarly to the first embodiment of the power storage system and the power storage device, by utilizing the battery voltage of the three-terminal secondary battery, the rotation speed of the rotor of the AC generator 12 can be controlled, while preventing an increase in cost. The number of circuit components and the like used to control the rotation speed of the AC generator 12 can be reduced, and thus, the reliability of the power storage system can be improved.

Note that, instead of the power storage system 280 illustrated in FIG. 10, the power storage systems 210, 220, 230, 240, and 250 of each of the embodiments described above may be mounted in the system 310. In this case, the loads 81 and 82 correspond to the voltmeter 91, the water level gauge 92, or the communication device 93.

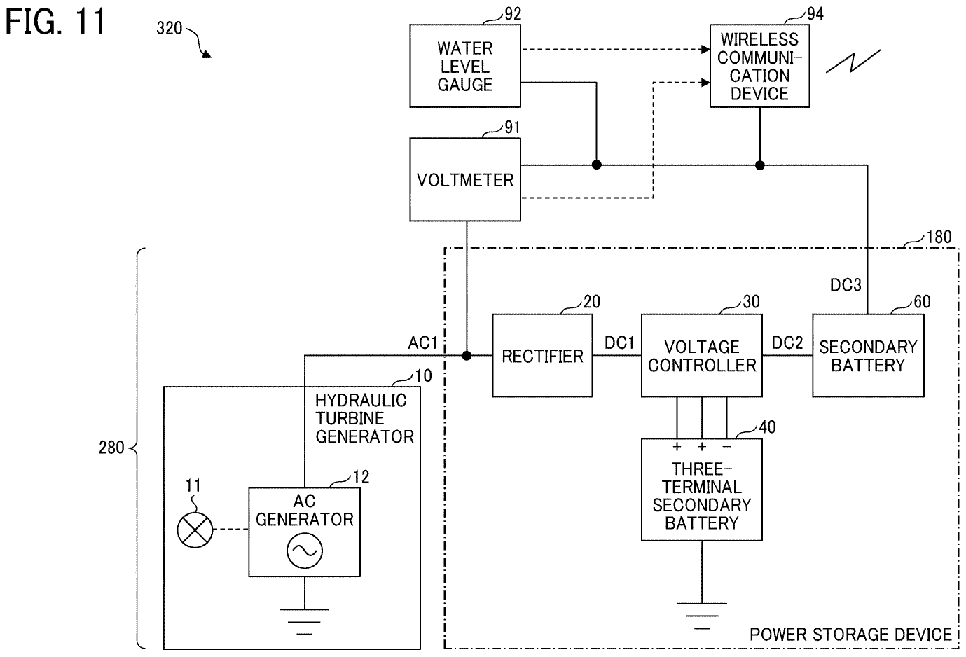

FIG. 11 is a block diagram illustrating a second embodiment of the system according to the present disclosure. Elements similar to those in FIGS. 1, 6, and 10 are denoted by the same reference numerals, and detailed description thereof will be omitted. A system 320 illustrated in FIG. 11 is similar to the system 310 of FIG. 10, except that the system 320 includes a wireless communication device 94 instead of the communication device 93.

As described above, also in the second embodiment of the system, a similar effect as in the first embodiment of the system can be obtained. Further, in the present embodiment, by operating the wireless communication device 94 by using the electric power stored in the power storage device 180, even if no wireless communication equipment such as a wireless Local Area Network (LAN) is provided, it is possible to a perform wireless communication with a relay base station in the vicinity or perform satellite communication. The wireless communication device 94 can transmit, at a predetermined frequency, the voltage value received from the voltmeter 91 and the water level received from the water level gauge 92 to a mobile device located at a remote location or a data storage device. Thus, even if the power storage system 280 is installed in an electricity-scarce area or a remote island where commercial power sources and the like cannot be used, the water amount, generated voltage, and the like can be confirmed via wireless communication.

Note that, instead of the power storage system 280 illustrated in FIG. 11, the power storage systems 210, 220, 230, 240, and 250 of each of the embodiments described above may be mounted in the system 320. In this case, the loads 81 and 82 correspond to the voltmeter 91, the water level gauge 92, or the communication device 93.

In each of the embodiments described above, an example is described in which electric power generated by the hydraulic turbine generator 10 is stored by the power storage devices 110, 120, 130, 140, 150, 160, and 180. However, electric power generated by a wind power generation device may be stored by the power storage devices 110, 120, 130, 140, 150, 160, and 180.

Aspects of the present disclosure include the following, for example.

According to a first aspect, a power storage system includes a rotating body,
a generator to convert a rotational force of the rotating body into electric power,
a secondary battery to store the electric power converted by the generator, and
a controller to electrically connect the generator and the secondary battery to each other and control storage of the electric power converted by the generator in the secondary battery, in which
the secondary battery includes a three-terminal secondary battery having two positive electrodes that are short-circuited with each other, and one negative electrode, and
by applying a battery voltage of the three-terminal secondary battery to the generator via the controller, power generation by the generator is controlled, and a rotation speed of a rotor of the generator is controlled.

According to a second aspect, in the power storage system according to the first aspect, the three-terminal secondary battery is connected in parallel with the generator.

According to a third aspect, in the power storage system according to the first aspect or the second aspect, the three-terminal secondary battery includes a lithium ion battery.

According to a fourth aspect, in the power storage system according to the third aspect, the three-terminal secondary battery has a positive electrode using an active material having a spinel structure or an olivine structure.

According to a fifth aspect, in the power storage system according to any one of the first to fourth aspects, the generator includes an AC generator to convert the rotational force of the rotating body into AC power, and
the power storage system further includes a rectifier to convert the AC power converted by the generator into DC power and supply the DC power that is converted, to the three-terminal secondary battery.

According to a sixth aspect, in the power storage system according to any one of the first to fourth aspects, the generator includes a DC generator to convert the rotational force of the rotating body into DC power.

According to a seventh aspect, in the power storage system according to any one of the first to sixth aspects, the rotating body includes a hydraulic turbine, and
the electric power generated by the generator is from 1 W to 30 kW.

According to an eighth aspect, a system includes the power storage system according to any one of the first to seventh aspects,
a sensor to operate in response to receiving electric power stored in the secondary battery, and a communication device to transmit a detection value detected by the sensor to outside of the power storage system.

According to a ninth aspect, in the system according to the eighth aspect, the communication device transmits the detection value to outside of the power storage system by wireless communication.

According to a tenth aspect, a power storage device includes a secondary battery to store electric power converted by a generator that converts a rotational force of a rotating body into electric power, and
a controller to electrically connect the generator and the secondary battery to each other and control storage of the electric power converted by the generator in the secondary battery, in which
the secondary battery includes a three-terminal secondary battery having two positive electrodes that are short-circuited with each other, and one negative electrode, and
by applying a battery voltage of the three-terminal secondary battery to the generator via the controller, power generation by the generator is controlled, and a rotation speed of a rotor of the generator is controlled.

The present embodiment has been described above based on embodiments. However, the present embodiment is not limited to the requirements indicated in the above-described embodiments. These aspects can be changed without departing from the gist of the present embodiment, and can be appropriately determined depending on the application thereof.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2022-187475, filed on Nov. 24, 2022, in the Japan Patent Office, the entire disclosure of which is hereby incorporated by reference herein.

### REFERENCE SIGNS LIST

10 Hydraulic turbine generator
11 Hydraulic turbine
12 AC generator
13 DC generator
20 Rectifier
30 Voltage controller
40 Three-terminal secondary battery
50 DC/AC converter
60 Secondary battery
71, 72 Switch
81,82 Load
91 Voltmeter
92 Water level gauge
93 Communication device
94 Wireless communication device
110, 120, 130, 140, 150, 160, 180 Power storage device
210, 220, 230, 240, 250, 260, 280 Power storage system
310, 320 System
BAT Storage terminal
IN Input terminal
OUT Output terminal

1. A power storage system, comprising:
a rotating body;
a generator to convert a rotational force of the rotating body into electric power;
a secondary battery to store the electric power converted by the generator; and
control circuitry configured to electrically connect the generator and the secondary battery to each other and control storage of the electric power converted by the generator in the secondary battery,
wherein:
the secondary battery includes a three-terminal secondary battery having two positive electrodes that are short-circuited with each other, and one negative electrode, and
by applying a battery voltage of the three-terminal secondary battery to the generator via the control circuitry power generation by the generator is controlled, and a rotation speed of a rotor of the generator is controlled.

2. The power storage system according to claim 1, wherein:
the three-terminal secondary battery is connected in parallel with the generator.

3. The power storage system according to claim 1, wherein:
the three-terminal secondary battery includes a lithium ion battery.

4. The power storage system according to claim 3, wherein:
the three-terminal secondary battery has a positive electrode using an active material having a spinel structure or an olivine structure.

5. The power storage system according to claim 1, wherein:
the generator includes an AC generator to convert the rotational force of the rotating body into AC power, and
the power storage system further includes a rectifier to convert the AC power converted by the generator into DC power and supply the DC power that is converted, to the three-terminal secondary battery.

6. The power storage system according to claim 1, wherein:
the generator includes a DC generator to convert the rotational force of the rotating body into DC power.

7. The power storage system according to claim 1, wherein:
the rotating body includes a hydraulic turbine, and
the electric power generated by the generator is from 1 W to 30 kW.

8. A system comprising:
the power storage system according to claim 1;
a sensor to operate in response to receiving electric power stored in the secondary battery; and
communication circuitry to transmit a detection value detected by the sensor to outside of the power storage system.

9. The system according to claim 8, wherein:
the communication circuitry transmits the detection value to outside of the power storage system by wireless communication.

10. A power storage device, comprising:
a secondary battery to store electric power converted by a generator that converts a rotational force of a rotating body into electric power; and
control circuitry configured to electrically connect the generator and the secondary battery to each other and control storage of the electric power converted by the generator in the secondary battery,
wherein:
the secondary battery includes a three-terminal secondary battery having two positive electrodes that are short-circuited with each other, and one negative electrode, and
by applying a battery voltage of the three-terminal secondary battery to the generator via the control circuitry power generation by the generator is controlled, and a rotation speed of a rotor of the generator is controlled.
